(19) United States
(12) Patent Application Publication
(10) Pub. No.: US 2017/0186294 A1
(43) Pub. Date: Jun. 29, 2017

(54) REGISTER SYSTEM THAT DEACTIVATES A SECURITY TAG ATTACHED TO A PRODUCT

(71) Applicant: TOSHIBA TEC KABUSHIKI KAISHA, Tokyo (JP)

(72) Inventors: Tsuyoshi GOTANDA, Ota Tokyo (JP); Norifumi SHISHIDO, Mishima Shizuoka (JP)

(21) Appl. No.: 15/384,281

(22) Filed: Dec. 19, 2016

(30) Foreign Application Priority Data
Dec. 25, 2015 (JP) 2015-253556

(51) Int. Cl. G08B 13/24

(52) U.S. Cl. CPC G08B 13/242; G08B 13/2425; G08B 13/246

(57) ABSTRACT

A register system includes a handheld unit including a code scanner and a security tag signal reception unit and a processor. The processor is configured to determine whether or not a security tag on a product is deactivated based on whether or not the security tag signal reception unit receives a security tag signal from the product during scanning of a product code on the product, and register the product code for a transaction when the security tag is determined to be deactivated.

### CROSS-REFERENCE TO RELATED APPLICATION

This application is based upon and claims the benefit of priority from Japanese Patent Application No. 2015-253556, filed Dec. 25, 2015, the entire contents of which are incorporated herein by reference.

### FIELD

An embodiment described herein relates generally to a register system including a merchandise reading apparatus.

### BACKGROUND

A security system of one type generates an alarm if a security tag that is not deactivated is placed proximate to a security gate located at an exit of a store. In such a security system, the security tag is attached to merchandise and deactivated at the time of checkout.

Specifically, deactivation of the security tag is performed by placing the security tag near a deactivator.

In the security system, if the deactivation of the security tag is not properly performed even if merchandise is properly purchased, the security gate generates an alarm when a shopper goes through the security gate with purchased merchandise on which the security tag is attached. This false alarm may require a store staff to confirm the purchase of the merchandise, and also annoy the shopper. Therefore, it is desirable to minimize the occurrence of the false alarm.

### DESCRIPTION OF THE DRAWINGS

FIG. 1 illustrates a store cashier system that includes a merchandise reading apparatus according to an embodiment.

FIG. 2 is a block diagram of the store cashier system illustrated in FIG. 1.

FIG. 3 illustrates a structure of a data record included in a PLU file.

FIG. 4 is a flowchart illustrating a control process carried out by a CPU of the merchandise reading apparatus.

FIG. 5 illustrates an example of a notification screen.

FIG. 6 illustrates an example of a deactivation-in-progress screen.

### DETAILED DESCRIPTION

An embodiment provides a merchandise reading apparatus that is capable of lowering a possibility of a false alarm in a security system when a shopper properly takes out a purchased merchandise item outside a store.

According to an embodiment, a register system includes a handheld unit including a code scanner and a security tag signal reception unit and a processor. The processor is configured to determine whether or not a security tag on a product is deactivated based on whether or not the security tag signal reception unit receives a security tag signal from the product during scanning of a product code on the product, and register the product code for a transaction when the security tag is determined to be deactivated.

Hereinafter, an embodiment of a merchandise reading apparatus and a merchandise registration apparatus including the merchandise reading apparatus will be described with reference to the drawings. The embodiment is related to a case where the merchandise registration apparatus is introduced as a store cashier system in a store such as a supermarket which reads a price look up (PLU) code as an identification code of a sold merchandise item and registers the PLU code for the sold merchandise item.

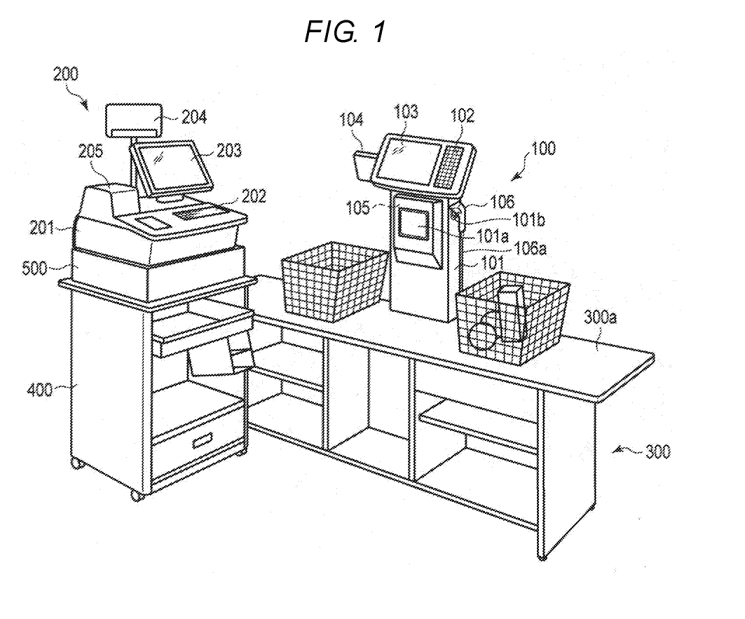

FIG. 1 illustrating a store cashier system that includes a merchandise reading apparatus according to the embodiment.

The store cashier system illustrated in FIG. 1 includes a merchandise reading apparatus 100 and a POS terminal 200. The merchandise reading apparatus 100 is attached on a cashier counter 300. The POS terminal 200 is provided on a drawer 500 which is mounted on a register table 400. The merchandise reading apparatus 100 and the POS terminal 200 are electrically connected to each other via a communication cable (not shown). Instead of the drawer 500, an automatic change dispensing machine may be located.

The merchandise reading apparatus 100 includes a housing 101, a keyboard 102, a touch panel 103, a customer-side display 104, a fixed scanner 105, and a handy unit 106.

The housing 101 is flat box-shaped and disposed on the cashier counter 300. An upper end of the housing 101 supports the keyboard 102, the touch panel 103, and the customer-side display 104 and an inner portion of the housing 101 supports the fixed scanner 105. The housing 101 includes a reading window 101a that faces the fixed scanner 105 and enables an object positioned on the front of the reading window 101a to be scanned by the fixed scanner 105 via the reading window 101a. A placement stand 101b is attached to the housing 101. The handy unit 106 is hung on the placement stand 101b. The handy unit 106 is connected to the merchandise reading apparatus 100 via a cable 106a, and is used by being carried by an operator. Generally, the operator is a casher.

The POS terminal 200 includes a housing 201, a keyboard 202, an operator-side display 203, a customer-side display 204, and a printer 205.

The housing 201 supports the keyboard 202 with a portion of the keyboard 202 exposed to the outside. The operator-side display 203 and the customer side-display 204 are supported by the housing 201 being positioned on the outside, and the printer 205 is supported by an inner portion of the housing 201.

The cashier counter 300 includes a thin and long top board 300a. The cashier counter 300 divides a space into a customer path (back side in FIG. 1) extending along a longitudinal direction of the top board and an operator space (front side in FIG. 1). The housing 101 is positioned on the substantially central portion in the longitudinal direction of the top board 300a with the keyboard 102, the touch panel 103, and the reading window 101a facing the operator space and with the customer-side display 104 facing the customer path. An area of an upper surface of the top board 300a on an upstream side in a shopper movement direction with respect to the merchandise reading apparatus 100 is used as a space for placing merchandise items before sales registration which is a part of merchandise items that a shopper wants to purchase. In addition, an area of an upper surface of the top board 300a on a downstream side in the shopper movement direction with respect to the merchandise reading apparatus 100 is used as a space for placing merchandise after sales registration.

The register table 400 is positioned on the operator space side in such a manner that the register table 400 is positioned next to an end portion of the cashier counter 300 on the downstream side in a movement direction of a shopper in the customer path.

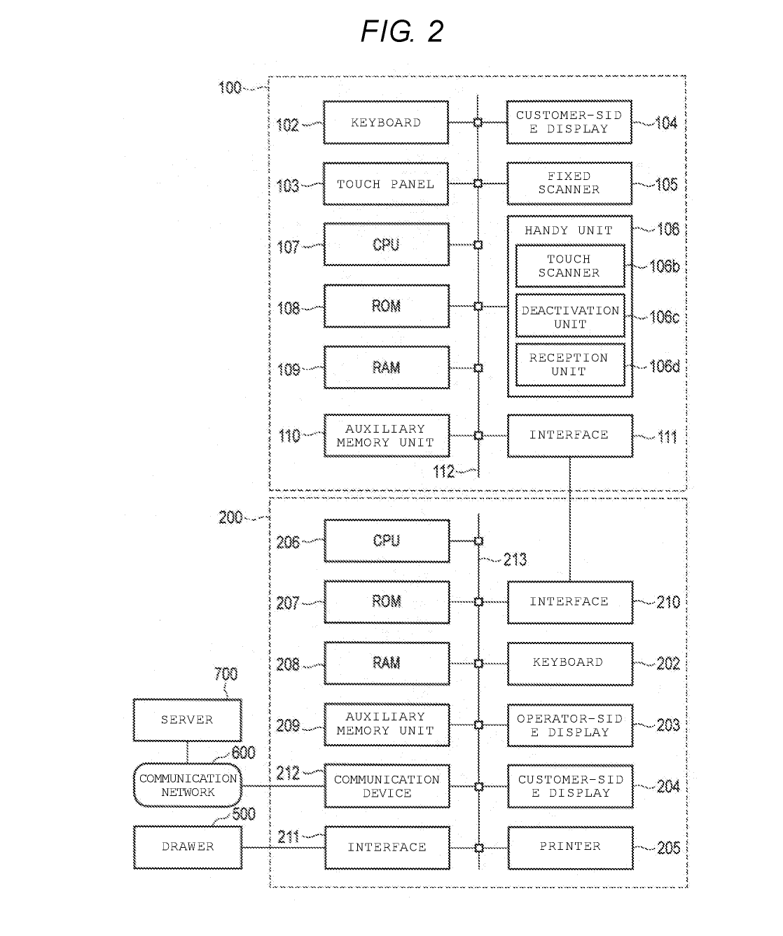

FIG. 2 is a block diagram of the store cashier system illustrated in FIG. 1. Elements shown in FIG. 2 which are the same as the elements shown in FIG. 1 are given the same reference numbers as in FIG. 1.

The merchandise reading apparatus 100 includes a central processing unit (CPU) 107, a read-only memory (ROM) 108, a random-access memory (RAM) 109, an auxiliary memory unit 110, an interface 111, and a bus line 112 in addition to the keyboard 102, the touch panel 103, the customer-side display 104, the fixed scanner 105, and the handy unit 106. The bus line 112 includes an address bus, a data bus, and the like and connects the keyboard 102, the touch panel 103, the customer-side display 104, the fixed scanner 105, the handy unit 106, the CPU 107, the ROM 108, the RAM 109, the auxiliary memory unit 110, and the interface 111 to each other.

The keyboard 102 includes a plurality of key switches and outputs a command indicating contents of an operation on the key switches by an operator.

The touch panel 103 includes a display device such as a liquid crystal display (LCD) and a transparent two-dimensional touch sensor which is disposed while overlapping a display screen of the display device. The touch panel 103 displays an arbitrary image on the display device under control of the CPU 107. The touch panel 103 detects a position of a portion of the display screen of the display device which is touched by an operator using the two-dimensional touch sensor and outputs coordinate data indicating the touch position. The touch panel 103 is used for displaying an image indicating various kinds of information supposed to be presented to an operator or for inputting an operator operation.

The customer side-display 104 displays an arbitrary character string or an arbitrary image under control of the CPU 107. The customer side-display 104 is used for displaying various character strings or images supposed to be presented to a customer. As the customer-side display 104, for example, a fluorescent tube display or an LCD can be used.

The fixed scanner 105 captures an image of a merchandise item placed in front of the reading window 101a by optically read information (hereinafter, referred to as barcode information) indicated by a barcode, which is a visible pattern formed on the merchandise item. The fixed scanner 105 outputs the read barcode information to the CPU 107. As the fixed scanner 105, another type of a known device which reads a barcode using laser light reflection may be used. Furthermore, as the fixed scanner 105, a type of a known device which has a function of specifying a merchandise item from an image, which is obtained by imaging the merchandise item, using an object identification technique may be used.

The handy unit 106 includes a touch scanner 106b, a deactivation unit 106c, and a reception unit 106d. If the handy unit 106 is placed proximate to a barcode on a merchandise item, the touch scanner 106b optically reads barcode information indicated by the barcode. If the handy unit 106 is placed proximate to a security tag attached to a merchandise item, the deactivation unit 106c deactivates the security tag. The reception unit 106d receives a signal transmitted by the security tag. The deactivation unit 106c, the reception unit 106d, and the security tag can be configured using the existing configuration without modification. For example, a security tag which is deactivated when receiving a specific radio wave can be used as the security tag, and a deactivation unit which transmits the specific radio wave is used as the deactivation unit 106c. This is referred to as a radio frequency (RF) system. For the security tag, an acoustic magnetic (AM) system and a radio frequency identification (RFID) system are also known, and the security tag and the deactivation unit 106c according to these systems may also be used. The deactivation unit 106c is an example of a deactivation means. Furthermore, as the reception unit 106d, an existing unit which is built into a security gate to receive a signal transmitted by the security tag may be used.

The CPU 107 controls each element of the merchandise reading apparatus 100 based on an operating system, middleware, and an application program stored in the ROM 108 and the RAM 109 so that various functions of the merchandise reading apparatus 100 are performed.

The ROM 108 stores the above-described operating system. The ROM 108 may store the above-described middleware or the above-described application program. Furthermore, the ROM 108 may store data which is referred to when the CPU 107 executes various processes.

The RAM 109 stores data which are referred to when the CPU 107 executes various processes. Furthermore, the RAM 109 is used as a so-called work area for storing data which are temporarily used when the CPU 107 executes various processes.

The auxiliary memory unit 110 stores data which are used when the CPU 107 executes various processes and stores data which are generated through a process carried out by the CPU 107. The auxiliary memory unit 110 may store the above-described middleware or the above-described application program. As the auxiliary memory unit, an electric erasable programmable read-only memory (EEPROM), a hard disk drive, or a solid state drive (SSD) can be used.

In this manner, the CPU 107, the ROM 108, the RAM 109 and the auxiliary memory unit 110 configure a computer. The CPU 107 corresponds to a central portion of the computer. The ROM 108 and the RAM 109 correspond to a main memory portion of the computer. The auxiliary memory unit 110 corresponds to an auxiliary memory portion of the computer.

The application program stored in the ROM 108 or the auxiliary memory unit 110 includes a control program, which will be described below in relation to a control process which will be described below. Generally, the merchandise reading apparatus 100 may be provided to a user with the control program stored in the ROM 108 or the auxiliary memory unit 110. Also, the merchandise reading apparatus 100 may be provided to a user without the control program stored in the ROM 108 or the auxiliary memory unit 110. A removable recording medium in which the control program is recorded may be provided to the user or the control program may be provided to the user via a network. The control program may be written in the auxiliary memory unit 110 of the merchandise reading apparatus 100, which is separately provided to the user, according to an operation of the user. As the recording medium, a magnetic disk, a magneto-optical disk, an optical disk, a semiconductor memory or the like can be used.

The interface 111 relays data between the POS terminal 200 and the CPU 107. As the interface 111, for example, a known device conforming to a USB standard or a RS-232C standard can be used.

The POS terminal 200 includes a CPU 206, a ROM 207, a RAM 208, an auxiliary memory unit 209, an interface 210, an interface 211, a communication device 212, and a bus line 213 as electrical elements in addition to the keyboard 202, the operator-side display 203, the customer-side display 204 and the printer 205. The bus line 213 includes an address bus, a data bus, and the like, and connects the CPU 206, the ROM 207, the RAM 208, the auxiliary memory unit 209, the interface 210, the interface 211 and the communication device 212 to each other.

The keyboard 202 includes a plurality of key switches and outputs a command indicating contents of an operation on the key switches by an operator.

The operator-side display 203 displays an arbitrary image under control of the CPU 206. The operator-side display 203 is used for displaying various images which are supposed to be presented to an operator. As the operator-side display 203, for example, an LCD can be used.

The customer-side display 204 displays an arbitrary character string or an arbitrary image under control of the CPU 206. The customer-side display 204 is used for displaying various character strings or images supposed to be presented to a customer. As the customer-side display 204, for example, a fluorescent tube display or an LCD can be used.

The printer 205 prints a receipt image which shows contents of a transaction on a receipt sheet under control of the CPU 206. As the printer 205, various known existing printers can be used. Typically, the printer 205 is a thermal printer.

The CPU 206 controls each unit of the POS terminal 200 based on an operating system, middleware, and an application program stored in the ROM 207 and the RAM 208, so that various functions of the POS terminal 200 are performed.

The ROM 207 stores the above-described operating system. The ROM 207 may store the above-described middleware or the above-described application program. Furthermore, the ROM 207 may store data which are referred to when the CPU 206 executes various processes.

The RAM 208 stores data which are referred to when the CPU 206 executes various processes. Furthermore, the RAM 208 is used as a so-called work area for storing data which are temporarily used when the CPU 206 executes various processes. A portion of a storage area of the RAM 208 is used as a merchandise list area which is used for management of information of merchandise after sales registration.

The auxiliary memory unit 209 is, for example, a hard disk drive, a SSD, or the like, and stores data which are used when the CPU 206 executes various processes and data which are generated through a process carried out by the CPU 206. The auxiliary memory unit 209 may store the above-described middleware or the above-described application program.

The interface 210 relays data between the merchandise reading apparatus 100 and the CPU 206. As the interface 210, for example, a known device conforming to the same standard as the interface 111 can be used.

The interface 211 outputs a driving signal for opening the drawer 500, to the drawer 500 when the CPU 206 issues an instruction to open the drawer.

The communication device 212 communicates with a server 700 via a communication network 600. As the communication device 212, for example, an existing LAN communication device can be used.

Next, an operation of the store cashier system configured as described above will be described.

Before the merchandise reading apparatus 100 is operated, a PLU file is stored in the RAM 109 or the auxiliary memory unit 110. The PLU file includes a plurality of data records which are related to respective merchandise items sold at a store in which the store cashier system is used.

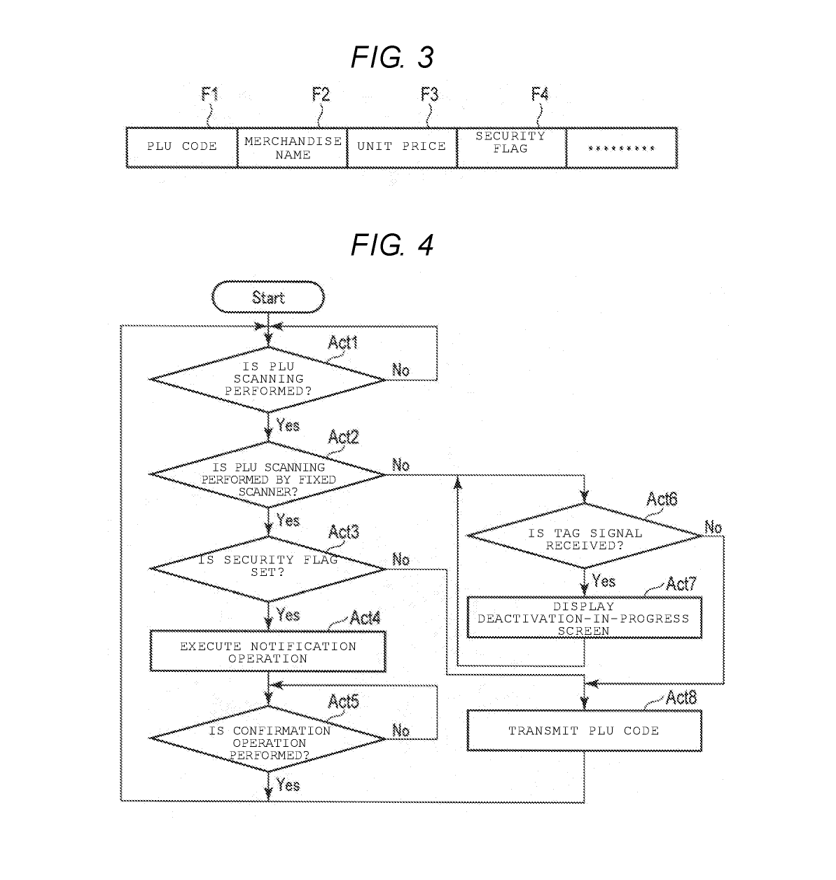

FIG. 3 illustrates a structure of a data record included in the PLU file.

The data record includes data fields of fields F1, F2, F3, and F4. The fields F1, F2, and F3 are set for a PLU code, which is an identification code of a corresponding merchandise item, a name, and a unit price of the merchandise item, respectively. The field F4 is set for a security flag. The security flag is one bit data which indicates whether or not the corresponding merchandise item is supposed to be attached with a security tag. In the present embodiment, it is assumed that a security flag is set for a merchandise item that is supposed to be with the a security tag. The merchandise item that is supposed to be with the security tag may be arbitrarily determined by an operation manager or the like of the store.

Typically, a master of the PLU file is managed by the server 700 or the like. The CPU 107 acquires the PLU file from the server 700 via the POS terminal 200 at a predetermined timing set in the merchandise reading apparatus 100. Then, the CPU 107 stores the acquired PLU file in the RAM 109 or the auxiliary memory unit 110. The predetermined timing may be an arbitrary timing. For example, the predetermined timing may be a timing at which the merchandise reading apparatus 100 is started, a timing at which a predetermined time is reached, or a timing at which the server 700 notifies that the PLU file is updated.

When the merchandise reading apparatus 100 is operated in a predetermined operation mode for sales registration or the like, the CPU 107 executes a control process according to the control program stored in the ROM 108 or the auxiliary memory unit 110.

FIG. 4 is a flowchart illustrating the control process of the CPU 107. The contents of a process described below are an example and various processes that lead to a similar result can be appropriately carried out.

In Act 1, the CPU 107 determines whether or not PLU scanning is performed by the fixed scanner 105 or the touch scanner 106b. When there is no PLU scanning, the CPU 107 determines that the result in Act 1 is NO and repeats Act 1. In this manner, the CPU 107 waits for PLU scanning in Act 1.

If a merchandise item with a barcode is registered as a sold merchandise item, the operator of the store cashier system places the barcode in front of the reading window 101a or places the touch scanner 106b proximate to the barcode. When the barcode is placed in front of the reading window 101a, the fixed scanner 105 reads the barcode. When the touch scanner 106b is placed proximate to the barcode, the touch scanner 106b reads the barcode. Barcode information indicated by a barcode on a merchandise item includes a PLU code which is an identification code of the merchandise item. The touch scanner 106b is an example of an inputting means.

The store cashier system is suitable for a store in which security tags are attached to only particular merchandise items for sale. The security tag is attached to a portion of each of the particular merchandise items proximate to a barcode thereof. Accordingly, when the merchandise item is placed proximate to the handy unit 106 for barcode scanning, the deactivation unit 106c comes proximate to the security tag attached to the merchandise item. Therefore, the security tag is deactivated by the deactivation unit 106c. If the barcode is placed in front of the reading window 101a so that the barcode is scanned by the fixed scanner 105, the security tag is not deactivated. The security tag transmits a predetermined signal in at least one of a non-deactivated state and a deactivated state. If the security tag transmits a signal in both of the non-deactivated state and the deactivated state, the security tag transmits a signal different for each state. Here, it is assumed that the security tag transmits a predetermined signal (hereinafter, referred to as a tag signal) in the non-deactivated state. Various security tags including a security tag which transmits a signal if the reception unit 106d comes proximate to the tag and a security tag which transmits a signal in response to a request from the reception unit 106d may be used. When the reception unit 106d receives a tag signal, the reception unit 106d writes notification information indicating the reception of the tag signal on the RAM 109.

When a barcode is scanned by the fixed scanner 105 or the touch scanner 106b, the CPU 107 determines whether or not a PLU code is included in barcode data obtained by the fixed scanner 105 or touch scanner 106b through the scanning. When it is determined that a PLU code is included in the barcode data, the CPU 107 determines that the PLU scanning is performed. That is, the CPU 107 determines that the result in Act 1 is YES, and proceeds to Act 2.

In Act 2, the CPU 107 determines whether or not the PLU scanning is performed by the fixed scanner 105. Specifically, the CPU 107 determines which of the fixed scanner 105 and the touch scanner 106b obtained the barcode data. When it is determined that the fixed scanner 105 obtained the barcode data, the CPU 107 determines that the result in Act 2 is YES, and proceeds to Act 3.

In Act 3, the CPU 107 determines whether or not the security flag is set. Specifically, the CPU 107 extracts the PLU code from the barcode data obtained by the fixed scanner 105. The CPU 107 searches a PLU file for a data record in which the PLU code is set in the field F1. When there is such a data record, the CPU 107 determines whether or not a security flag is set in the field F4 of the data record. When the security flag is set, the CPU 107 determines that the result in Act 3 is YES, and proceeds to Act 4.

In Act 4, the CPU 107 executes a notification operation. The notification operation is an operation of prompting the operator to scan the barcode again using the touch scanner 106b. The CPU 107 controls the touch panel 103 such that a guide screen for prompting the operator to scan the barcode again using the touch scanner 106b is displayed on the touch panel 103. When the CPU 107 executes the control process based on the control program in this manner, the computer that includes the CPU 107 as the central portion functions as a control means. In addition, the touch panel 103 is an example of an operation means which executes the notification operation. With cooperation of the computer that includes the CPU 107 as the central portion and the touch panel 103, a function as the notification means is achieved.

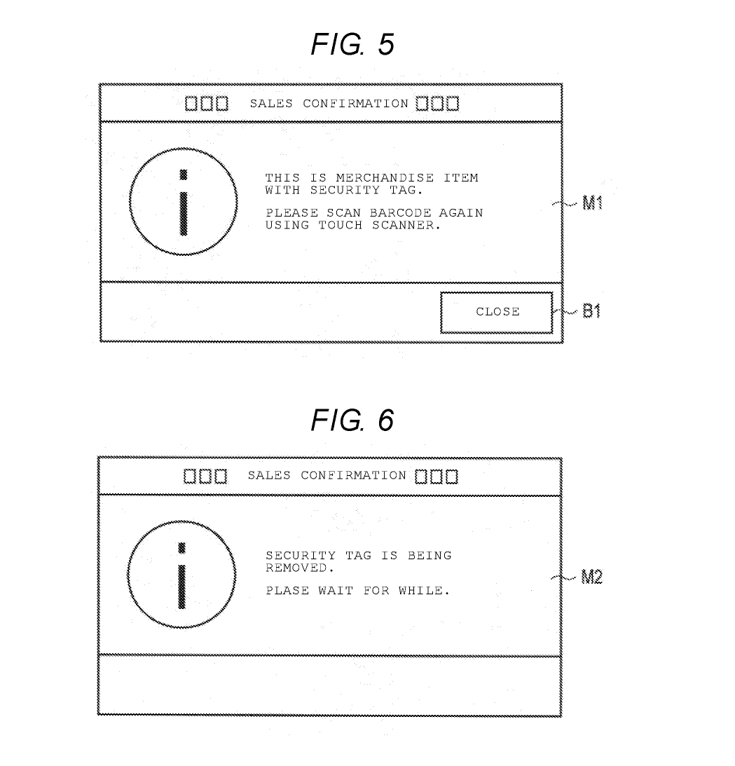

FIG. 5 illustrates an example of a notification screen.

The notification screen illustrated in FIG. 5 includes a character message M1 that prompts the operator to scan the barcode again using the touch scanner 106b.

As the notification operation, various operations of displaying the guide screen on the customer-side display 104, outputting a voice message, outputting a notification sound, and lighting up a notification lamp may be performed in addition to or instead of displaying the guide screen on the touch panel 103.

In Act 5, the CPU 107 determines whether or not a confirmation operation is performed. When the CPU 107 determines that the result in Act 5 is NO since there is no confirmation operation, the CPU 107 repeats Act 5. In this manner, the CPU 107 waits for the confirmation operation in Act 5.

Here, it is assumed that an operator needs to perform a predetermined confirmation operation on the guide screen (illustrated in FIG. 5). The predetermined confirmation operation may be an arbitrary operation. For example, the predetermined confirmation operation may be an operation of touching an object B1 displayed in the guide screen as illustrated in FIG. 5. When the confirmation operation is performed, the CPU 107 determines that the result in Act 5 is YES, and returns to a waiting state in Act 1.

When the CPU 107 determines that the result in Act 2 is NO since the barcode data are obtained by the touch scanner 106b, the CPU 107 proceeds to Act 6.

In Act 6, the CPU 107 determines whether or not the tag signal is received by the reception unit 106d. When the CPU 107 determines that the result in Act 6 is YES since the tag signal is received, the CPU 107 proceeds to Act 7.

In Act 7, the CPU 107 controls the touch panel 103 so that a deactivation-in-progress screen is displayed on the touch panel 103.

FIG. 6 illustrates an example of the deactivation-in-progress screen.

The deactivation-in-progress screen illustrated in FIG. 6 includes a character message M2 that notifies the operator that deactivation of the security tag is in progress and the handy unit 106 needs to be held to be proximate to the merchandise item.

Then, the CPU 107 returns to Act 6 with the deactivation-in-progress screen being displayed. In this manner, the CPU 107 repeats Act 6 and Act 7 until the tag signal is no longer received. If the CPU 107 proceeds to Act 7 with the deactivation-in-progress screen being displayed, the CPU 107 maintains the deactivation-in-progress screen being displayed. In this manner, in Act 6 and Act 7, the CPU 107 waits for the tag signal to be no longer received with the deactivation-in-progress screen being displayed.

When the security tag is deactivated by the deactivation unit 106c, the reception unit 106d cannot receive the tag signal. When the CPU 107 determines that the result in Act 6 is NO, the CPU 107 proceeds to Act 8. At this time, if the deactivation-in-progress screen is displayed, display of the screen may be terminated. In addition, when the CPU 107 determines that the result in Act 3 is NO since the security flag is not set, the CPU 107 proceeds to Act 8.

In Act 8, the CPU 107 transmits the PLU code which is obtained through the PLU scanning to the POS terminal 200. Specifically, when the CPU 107 proceeds to Act 8 from Act 2, the CPU 107 extracts the PLU code from the barcode data obtained by the touch scanner 106b, and controls the interface 111 to transmit the barcode data to the POS terminal 200. When the CPU 107 proceeds to Act 8 from Act 3, the CPU 107 controls the interface 111 to transmit the PLU code which is extracted in Act 3 to the POS terminal 200. Then, the CPU 107 returns to the waiting state in Act 1.

In the POS terminal 200, the interface 210 receives the PLU code transmitted from the interface 111 as described above. In this case, the CPU 206 adds the received PLU file to a list of sold merchandise. That is, the CPU 206 receives notification of the PLU code from the merchandise reading apparatus 100 and registers a merchandise item which is identified by the PLU code as a sold merchandise item.

According to the present embodiment, when the security tag is attached to a merchandise item, the CPU 107 captures the PLU code obtained using the touch scanner 106b as a validly read PLU code after confirming that the security tag is deactivated. That is, if there is no tag signal received by the reception unit 106d when the PLU code of the merchandise item as an attachment target of the security tag is obtained, the CPU 107 determines that the security tag attached to the merchandise item is deactivated. When the CPU 107 executes the control process based on the control program in this manner, the computer that includes the CPU 107 as the central portion functions as a confirming means in cooperation with the reception unit 106d. In addition, the CPU 107 captures the obtained PLU code as a validly input PLU code if it is determined that the security tag is deactivated as described above. When the CPU 107 executes the control process based on the control program in this manner, the computer that includes the CPU 107 as the central portion functions as a capturing means. In addition, with cooperation of the computer that includes the CPU 107 as the central portion and the computer that includes the CPU 206 as the central portion, a function as a registration means is achieved.

When the security tag is not attached to a merchandise item which is identified by the PLU code obtained by using the touch scanner 106b, the CPU 107 captures the PLU code as a validly-read PLU code. In addition, when the security tag is not attached to a merchandise item which is identified by the PLU code obtained using the fixed scanner 105, the CPU 107 captures the PLU code as a validly-read PLU code.

As described above, the upper surface of the top board 300a includes a space for placing merchandise items before sales registration and a space for placing merchandise items after sales registration with the merchandise reading apparatus 100 between the spaces. Therefore, the operator generally moves a sold merchandise item between the two spaces through an area in front of the reading window 101a. That is, the reading window 101a faces a traffic line of the movement of the sold merchandise item, and a scanning operation using the fixed scanner 105 is excellent in operability in comparison with a scanning operation using the touch scanner 106b. Therefore, the operator is more likely to carry out a scanning operation using the fixed scanner 105. If a security flag relating to the PLU file is not set in the PLU code obtained through the scanning operation using the fixed scanner 105, the PLU code is transmitted to the POS terminal 200. That is, if a sold merchandise item to which the security tag is not attached is scanned by the fixed scanner 105, the PLU code obtained through the scanning operation is transmitted to the POS terminal 200.

If a sold merchandise item to which the security tag is not attached is scanned by the fixed scanner 105, the security tag is not deactivated. However, if a security flag relating to the PLU file is set in the PLU code obtained through the scanning operation using the fixed scanner 105, the notification operation is performed to prompt the operator to scan the barcode again using the touch scanner 106b. In this case, the PLU code obtained through the scanning operation using the fixed scanner 105 is not transmitted from the merchandise reading apparatus 100 to the POS terminal 200. When the operator scans the barcode again using the touch scanner 106b according to the notification in the notification operation, the security tag is deactivated by the deactivation unit 106c. Then, the PLU code obtained through the scanning operation using the touch scanner 106b is transmitted to the POS terminal 200.

Accordingly, the operator may try the scanning operation using the fixed scanner 105 whether or not a sold merchandise item is a merchandise item to which the security tag is attached. If the notification operation is performed, the operator may scan the barcode again using the touch scanner 106b. Accordingly, workload of the operator can be minimized in comparison with a case where the operator needs to determine whether or not the security tag is attached to a merchandise item for each merchandise item and performs an operation for deactivating the security tag if the security tag is attached to a merchandise item.

Since the PLU code obtained through the scanning operation using the fixed scanner 105 for a merchandise item to which the security tag is attached is not transmitted to the POS terminal 200, the sales registration in the POS terminal 200 is not performed if there is a security tag that has not been deactivated.

In addition, the PLU code obtained through the scanning operation using the touch scanner 106b for a merchandise item to which a non-deactivated security tag is attached is not transmitted to the POS terminal 200 until the tag signal is no longer received, that is, until the security tag is deactivated. Therefore, a merchandise item to which a security tag that has not been properly deactivated is attached is not subject to the sales registration in the POS terminal 200.

Various modifications can be made to the embodiment as follows.

In the above embodiment, the touch scanner 106b is used as the inputting means. However, the inputting means can be appropriately modified. For example, the fixed scanner 105 may be used as the inputting means. In this case, the deactivation unit 106c is provided to deactivate a security tag attached to a merchandise item placed in front of the reading window 101a. In addition, the reception unit 106d is provided to receive a signal transmitted from a security tag attached to a merchandise item placed in front of the reading window 101a.

The deactivation unit 106c may be provided to deactivate the security tag at a timing different from a timing at which the PLU code is read. For example, the deactivation unit 106c may be provided on the top board 300a. In this case, the deactivation unit 106c may not be included in the merchandise reading apparatus 100 and may be attached to the outside of the merchandise reading apparatus 100 as a separate device. In such a configuration, an operation rule is set in which the PLU code is read after the security tag is deactivated by the deactivation unit 106c. If the PLU code is read without deactivation of the deactivation unit 106c, the CPU 107 does not transmit the PLU code to the POS terminal 200.

The CPU 107 may proceed to Act 8 from Act 2 skipping Act 3 to Act 5.

Instead of the PLU file, a data file can be used which indicates at least one of a PLU codes list of a merchandise item to which the security tag is attached and a PLU codes list of a merchandise item to which the security tag is not attached. In this case, if an obtained PLU code is included in the former list or if the obtained PLU code is not included in the latter list, the CPU 107 proceeds to Act 4 from Act 3.

It is also possible to use a POS terminal or a cash register which has a function of the merchandise reading apparatus 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A register system comprising:
a handheld unit including a code scanner and a security tag signal reception unit; and
a processor configured to determine whether or not a security tag on a product is deactivated based on whether or not the security tag signal reception unit receives a security tag signal from the product during scanning of a product code on the product, and register the product code for a transaction when the security tag is determined to be deactivated.

2. The register system according to claim 1, wherein
the handheld unit further includes a security tag deactivation unit that deactivates the security tag on the product when the code scanner is in a position to scan the produce code on the product.

3. The register system according to claim 2, further comprising:
a display, wherein
the processor is further configured to control the display to display a message that the security tag is being deactivated and to maintain the code scanner in the position to scan the product code on the product, when the security tag is determined to be not deactivated.

4. The register system according to claim 3, further comprising:
a fixed code scanner, wherein
the processor is further configured to
determine whether or not a product corresponding to a product code on the product and read by the fixed code scanner, is associated with a security tag, by referring to a product file using the product code read by the fixed code scanner,
register the product code for a transaction, when the product is determined to be not associated with the security tag, and
control the display to display an instruction to deactivate the associated security tag, without registering the product code, when the product is determined to be associated with the security tag.

5. The register system according to claim 4, wherein
the instruction to deactivate the associated security tag is to scan the product code on the product using the code scanner of the handheld unit.

6. The register system according to claim 5, wherein
the processor is further configured to control the display to stop displaying the instruction when the security tag is determined to be deactivated.

7. The register system according to claim 1, wherein
the security tag signal reception unit is configured to detect at least one of a radio frequency (RF) signal, an acoustic magnetic (AM) signal, and a radio frequency identification (RFID) signal from the security tag.

8. A non-transitory computer readable medium comprising a program that is executable in a register system having handheld unit that houses a code scanner and a security tag signal reception unit, wherein the program when executed in the register system causes the register system to perform a method for processing product registration, said method comprising:
while a product code on a product is being scanned by the code scanner that has been moved to a scanning position, determining by the signal reception unit whether or not a security tag signal is detected;
if the security tag signal is detected, displaying an instruction to keep the handheld unit at the scanning position; and
if the signal is not detected, registering the product code for a transaction.

9. The non-transitory computer readable medium according to claim 8, wherein the handheld unit further includes a security tag deactivation unit that deactivates a security tag on the product when the code scanner is in the scanning position.

10. The non-transitory computer readable medium according to claim 8, wherein the register system further includes a fixed code scanner and the method further comprises:
responsive to a product code of a product being scanned by the fixed code scanner, determining whether or not the product is associated with a security tag, by referring to a product file using the product code read by the fixed code scanner;
registering the product code for a transaction, when the product is determined to be not associated with the security tag; and
displaying an instruction to deactivate the associated security tag, without registering the product code, when the product is determined to be associated with the security tag.

11. The non-transitory computer readable medium according to claim 10, wherein
the instruction to deactivate the associated security tag is to scan the product code on the product using the code scanner of the handheld unit.

12. The non-transitory computer readable medium according to claim 11, wherein the method further comprises:
stopping the display of the instruction when the security tag is determined to be deactivated.

13. The non-transitory computer readable medium according to claim 8, wherein
the security tag signal reception unit is configured to detect at least one of a radio frequency (RF) signal, an acoustic magnetic (AM) signal, and a radio frequency identification (RFID) signal from the security tag.

14. A method for processing product registration using a register system having handheld unit that houses a code scanner and a security tag signal reception unit, said method comprising:
while a product code on a product is being scanned by the code scanner that has been moved to a scanning position, determining by the signal reception unit whether or not a security tag signal is detected;
if the security tag signal is detected, displaying an instruction to keep the handheld unit at the scanning position; and
if the signal is not detected, registering the product code for a transaction.

15. The method according to claim 14, wherein the handheld unit further includes a security tag deactivation unit that deactivates a security tag on the product when the code scanner is in the scanning position.

16. The method according to claim 14, wherein the register system further includes a fixed code scanner and the method further comprises:
responsive to a product code of a product being scanned by the fixed code scanner, determining whether or not the product is associated with a security tag, by referring to a product file using the product code read by the fixed code scanner;
registering the product code for a transaction, when the product is determined to be not associated with the security tag; and
displaying an instruction to deactivate the associated security tag, without registering the product code, when the product is determined to be associated with the security tag.

17. The method according to claim 16, wherein
the instruction to deactivate the associated security tag is to scan the product code on the product using the code scanner of the handheld unit.

18. The method according to claim 17, further comprising:
stopping the display of the instruction when the security tag is determined to be deactivated.

19. The method according to claim 14, wherein
the security tag signal reception unit is configured to detect at least one of a radio frequency (RF) signal, an acoustic magnetic (AM) signal, and a radio frequency identification (RFID) signal from the security tag.
